(19) United States
(12) Patent Application Publication
(10) Pub. No.: US 2017/0286390 A1
(43) Pub. Date: Oct. 5, 2017

(54) DYNAMIC AND AUTOMATIC GENERATION OF INTERACTIVE TEXT RELATED OBJECTS

(71) Applicant: CONTEXTORS LTD., HOLON (IL)

(72) Inventors: DROR YASHPE, KFAR-HESS (IL); DOR KALEV, HOLON (IL); MICHAL YASHPE, HOLON (IL)

(21) Appl. No.: 15/478,254

(22) Filed: Apr. 4, 2017

Related U.S. Application Data
(60) Provisional application No. 62/317,716, filed on Apr. 4, 2016.

(51) Int. Cl. G06F 17/24; G06F 3/0486; G06F 17/22; G06F 3/0482; G06F 17/27

(52) U.S. Cl. CPC G06F 17/248; G06F 3/0482; G06F 17/274; G06F 17/2735; G06F 17/2247; G06F 3/0486; G06F 17/271

(57) ABSTRACT

A method for enhancing a text presentation comprising: performing a linguistic analysis of a plurality of sentences, each comprising a plurality of linguistic elements, in a text content, using analyzed data created by said linguistic analysis to match between a group of said plurality of sentences and a plurality of interactive text related object templates, creating a plurality of interactive text related objects each for a member of said group, each one of said plurality of interactive text related objects is created by placing a respective said analyzed data into a respective said interactive text related object template, and causing a client device to present simultaneously at least one of said plurality of interactive text related objects and a text section of said text content that includes a marking of at least one linguistic element of a respective member of said group.

### RELATED APPLICATION/S

This application claims the benefit of priority under 35 USC §119(e) of U.S. Provisional Patent Application No. 62/317,716 filed on Apr. 4, 2016, the contents of which are incorporated herein by reference in their entirety.

### FIELD AND BACKGROUND OF THE INVENTION

The present invention, in some embodiments thereof, relates to gamification and, more particularly, but not exclusively, to processes and devices for linguistic gamification.

A popular process for enhancing skills today is gamification. The origin of the gamification concept is video game industry. The idea of gamification is in embedding interactive and game-based techniques into application to increase both user engagement and the time they spend. Due to the insufficiency of exploration, gamification is rarely used in basic skills such as languages. Games with a purpose (GWAPs), namely games wherein a player without any special knowledge is put into a gaming environment and has to make right decisions to win the game under the pressure of time or any game mechanics' constraints. In the linguistic learning field, examples of such games are Phrase Detectives™ and JeuxDeMots.

### SUMMARY OF THE INVENTION

According to some embodiments of the present invention, there is provided a method for enhancing a text presentation. The method comprises performing a linguistic analysis of a plurality of sentences, each comprising a plurality of linguistic elements, in a text content, using analyzed data created by the linguistic analysis to match between a group of the plurality of sentences and a plurality of interactive text related object templates, creating a plurality of interactive text related objects each for a member of the group, each one of the plurality of interactive text related objects is created by placing a respective the analyzed data into a respective the interactive text related object template, and causing a client device to present simultaneously at least one of the plurality of interactive text related objects and a text section of the text content that includes a marking of at least one linguistic element of a respective member of the group.

Optionally, the performing a linguistic analysis comprises parsing the plurality of linguistic elements of each one of the plurality of sentences to one of a plurality of parsed syntactic structure trees; wherein the analyzed data comprises the plurality of parsed syntactic structure trees.

Optionally, the method further comprises identifying enriching data related to at least some of the plurality of linguistic elements of at least some of the plurality of sentences by submitting a search query that includes data extracted using a respective the parse tree and using the enriching data for creating the plurality of interactive text related objects.

Optionally, the plurality of interactive text related objects comprises instructions to present a plurality of graphical user interfaces each having a question and a plurality of answers and adapted to react to a user selection made using a man machine interface of the client device.

Optionally, the plurality of interactive text related objects comprises instructions to present explanation content related to the at least one marked linguistic element.

Optionally, the method further comprises identifying grammatical functions defining at least some of the plurality of linguistic elements of at least some of the plurality of sentences and using the grammatical functions for creating the plurality of interactive text related objects.

Optionally, the method further comprises identifying dictionary data defining at least some of the plurality of linguistic elements of at least some of the plurality of sentences and using the dictionary data for creating the plurality of interactive text related objects.

Optionally, the method further comprises identifying enriching data related to at least some of the plurality of linguistic elements of at least some of the plurality of sentences by executing a script and using the enriching data for creating the plurality of interactive text related objects.

Optionally, each one of the plurality of interactive text related object templates comprises at least one condition; wherein the match is found when data defining at least some of the plurality of linguistic elements complies with the at least one condition.

Optionally, the causing comprises forwarding the plurality of interactive text related objects to the client device over a network so as to allow the client device to embed the plurality of interactive text related objects into a presentation of the text content.

Optionally, the plurality of interactive text related objects is locally created by the client device.

More optionally, the plurality of interactive text related objects are encoded in a JavaScript Object Notation (JSON) file.

Optionally, text content is in a HyperText Markup Language (HTML) format.

Optionally, the method further comprises selecting which of the plurality of interactive text related objects to present or which of the interactive text related object templates to use based on an estimation of at least one linguistic skill of a user.

Optionally, the method further comprises selecting which of the plurality of interactive text related objects to present or which of the interactive text related object templates to use based on a level set by an operator.

Optionally, the plurality of interactive text related objects comprises instructions to present a graphical user interface adapted to allow a user to drag and drop dynamically created objects using a man machine interface of the client device.

Optionally, at least one of the plurality of interactive text related objects is a GUI comprising a question and multiple answers which are created by placing data extracted using the respective parse tree into the respective interactive text related object template.

According to some embodiments of the present invention, there is provided a system for enhancing a text presentation. The system comprises a database comprising a plurality of interactive text related object templates, a code store storing a code, at least one processor coupled to the database for executing the stored code, the code comprising: code to perform a linguistic analysis of each of a plurality of sentences in a text content, each one of the plurality of sentences comprises a plurality of linguistic elements, code to use analyzed data from the linguistic analysis to match between a group of the plurality of sentences and a plurality of interactive text related object templates, code to create a plurality of interactive text related objects each for a member of the group, each one of the plurality of interactive text related objects is created by placing data extracted using a respective the analyzed data into a respective the interactive text related object template, and code to forward to a client device instructions to present at least one of the plurality of interactive text related objects in relation to a presentation of a text section of the text content that includes a marking of at least one linguistic element of a respective member of the group.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for enhancing a presentation of text content with interactive text related objects, according to some embodiments of the present application;

FIG. 2 is a schematic illustration of a system for enhancing a presentation of text content with dynamically generated interactive text related object(s) for example as defined in the process depicted in FIG. 1, according to some embodiments of the present application;

FIG. 3 is a schematic illustration data flows between software modules used for executing the method depicted in FIG. 1, according to some embodiments of the present application;

FIG. 4 is a schematic illustration of an exemplary three level syntactic structure tree created according to some embodiments of the present application;

FIGS. 5A-5B are two exemplary three level parse trees created according to some embodiments of the present application; and

FIGS. 6A-6G are exemplary interactive text related objects created according to some embodiments of the present application.

### DESCRIPTION OF SPECIFIC EMBODIMENTS OF THE INVENTION

The present invention, in some embodiments thereof, relates to gamification and, more particularly, but not exclusively, to processes and devices for linguistic gamification.

According to some embodiments of the present invention, there are provided systems and methods for dynamically creating interactive text related objects, such as interactive challenge graphical user interface(s) and/or linguistic educational items for enhancing any text content. The dynamically created interactive text related objects are designed to be presented together with portions of the text content, providing a reader (also referred to as a user) with a layer of interactive educational experience that is presented on top and/or in parallel to the text content she selected for reading. In such a manner, the provided educational experience does not enforce the user to read a preselected text content but rather allows the user to select which text content to enhance with challenges or educational items.

According to some embodiments of the present invention, linguistic elements such as words in each sentence of the text content or a portion thereof (referred to herein as a text content) are processed according to a linguistic analysis, for example part of speech (POS) tagging, phrase structure parsing, dependency parsing, word sense disambiguation, and/or anaphora resolution. In some embodiments, the sentence is parsed to create a sentence structure tree, such as parse tree.

The parse tree is used for creating a sentence object, for example a record, that stores data regarding the sentence. The sentence object is optionally enriched with data extracted from dictionaries, scripts and/or other mechanism for mapping linguistic information. One or more interactive text related object templates are matched with data extracted from the created sentence objects for identifying a group of interactive text related object templates which are suitable for creating interactive text related objects related to some sentences in the text content. By inputting sentence object data into the group of interactive text related object templates, the suitable interactive text related objects are created. The created interactive text related objects can now be embedded for presentation to the user, optionally in parallel to the presentation of the text content.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

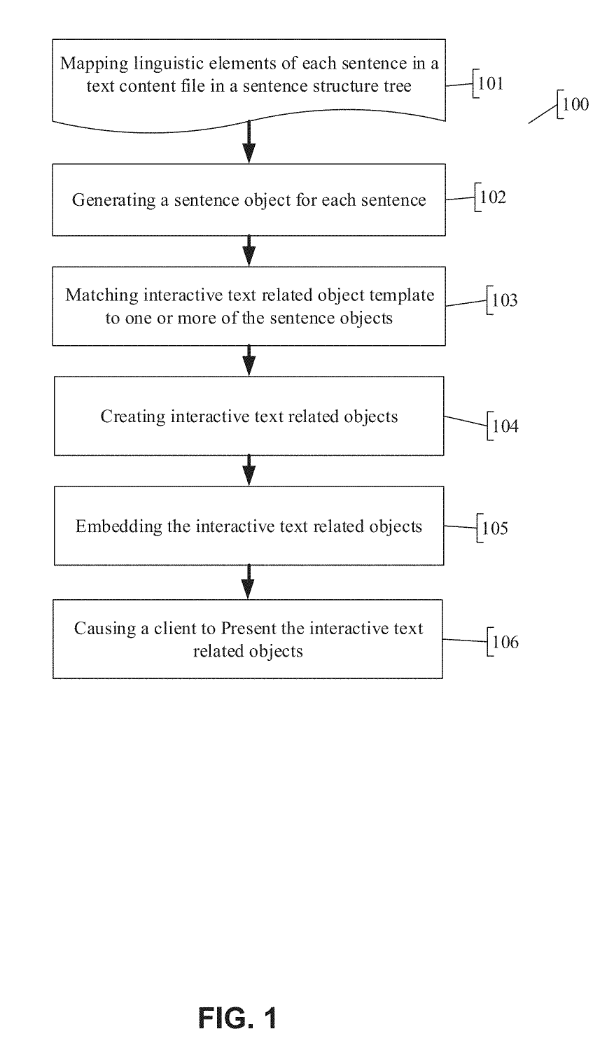

Reference is now made to FIG. 1, which is a flowchart 100 of a method for enhancing a presentation of text content with interactive text related objects, such as interactive challenge graphical user interface(s) and/or linguistic educational items dynamically built based on a template, an analysis of the text content and optionally an analysis of a user profile, according to some embodiments of the present application. The method, which is optionally executed in one or more servers, virtual machine(s) or on a client terminal such as a smartphone, a tablet, a laptop and/or any other personal mobile device, automatically enhances a display of a portion of text content by adding an interactive learning platform. In such a manner, linguistic abilities of a user may be improved by enhancing her favorite text content and/or textual sections with interactive text related objects selected based on a profile analysis.

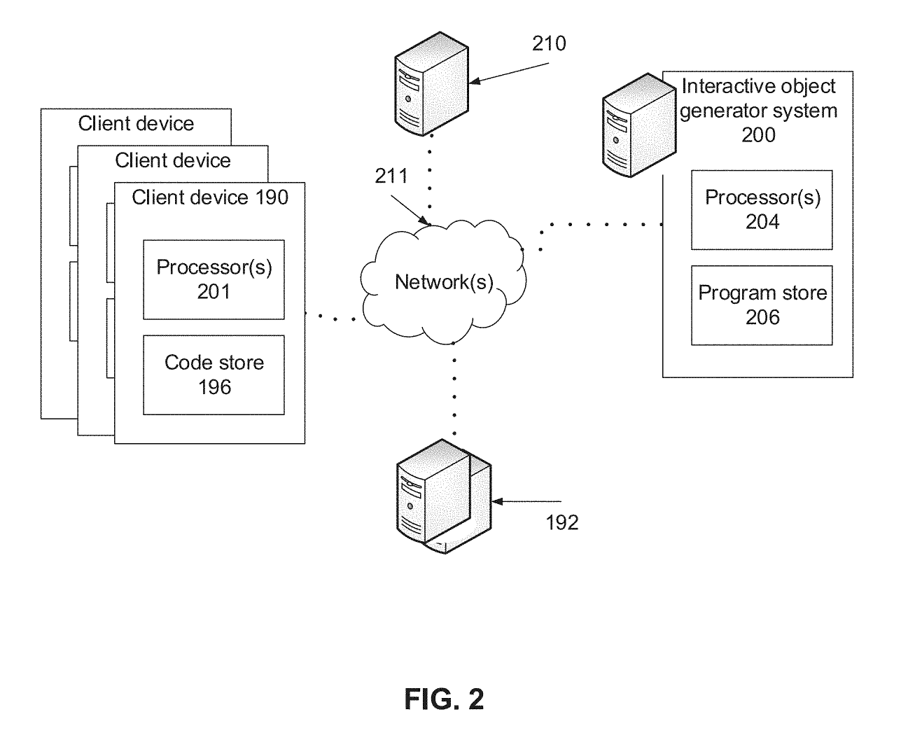

Reference is also made to FIG. 2, which is a schematic illustration of a system 200, referred to also as an interactive object generator system 200 for enhancing a presentation of text content with dynamically generated interactive text related object(s), for instance by using one or more processors for executing code instructions defined as the process depicted in FIG. 1, according to some embodiments of the present application. The system 200 is optionally implemented on server(s) that include one or more processor(s) 204 and a program store 206 hosting a text enhancing module, such as a software code adapted to be executed by the one or more processor(s) for executing a process for enhancing a presentation of text content with interactive text related objects, for instance as depicted in FIG. 1. The system 200 further includes a network interface for communication via network(s) 211, for example the World Wide Web.

FIG. 2 also depicts a plurality of client devices 190, such as laptops, tablets, smartphones, mobile computing units and/or the like. Each client device includes one or more processor(s) 201 and a program store 196 hosting a client module, also referred to as a front end application, such as a web browser, an application and/or an add-on adapted to present text content enhanced with dynamically generated interactive text related object(s). FIG. 2 also depicts text media server(s) 192 which may be designated web servers and/or any servers hosting network documents such as webpages and/or the like.

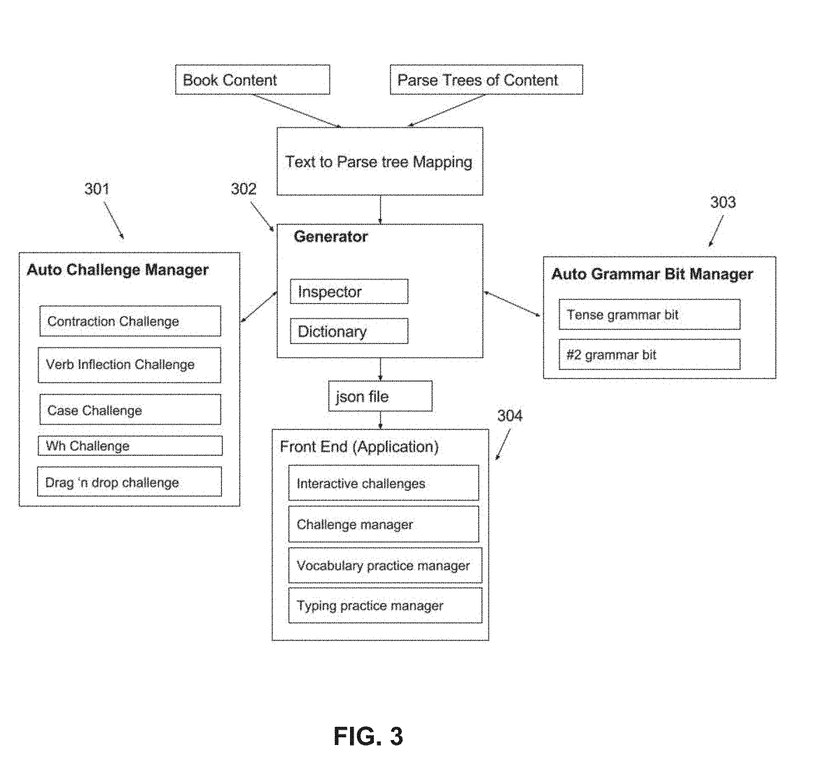

Reference is also made to FIG. 3, which is a schematic illustration data flows between software modules used for executing the method depicted in FIG. 1, according to some embodiments of the present application. FIG. 3 depicts modules executed by processors of the system 200, namely an auto challenge manager 301, a generator 302, an auto grammar bit manager 303 and modules executed by processors of the client device 190, namely a front end application 304. The modules are logical modules that include sub-modules also implemented by code instructions or non transitory memory segments, and represented by inner boxes. It should be noted that some of the modules executed by processors of the system 200 may be executed by processors of the client device 190.

First, as shown at 101, a file with text content is processed by the one or more processor(s) 204 to map a plurality of linguistic elements in the text content, for example words, word pairs, word triplets, word quadruplet, terms, and/or phrases.

The text content is optionally acquired via the network interface of the system 200, for example from text media server(s) 192 which may be designated web servers and/or any servers hosting network documents such as webpages and/or the like. The text content is optionally received or designated by the client device 190, for instance based on a user selection in an application and/or a browser. The user selection may be explicit, for example of a file or content and/or implicit, for instance by accessing text content using an application and/or a browser. An indication of a selected text content may be sent to the system, for instance as a unique identifier, and/or a uniform resource identifier (URI) such as a uniform resource locator (URL).

Optionally, the text content is in a HyperText Markup Language (HTML) format. In such embodiments, every word is marked with a tag, for instance a <span> tag, and each sentence is marked with a tag and an index of its sequential number. For example, an HTML representation of the sentence “Once upon a time there was a little princes”:

<span class=“sentence” data-id=“1”>

<span>Once</span>
<span>upon</span>
<span>a</span>
<span>time</span>
<span>there</span>
<span>was</span>
<span>a</span>
<span>little</span>
<span>princes</span>

</span>

Optionally, the processing of the text content is held by linguistic analysis, for example part of speech (POS) tagging, phrase structure parsing, dependency parsing, word sense disambiguation, and/or anaphora resolution. In some embodiments, the sentence is parsed to create a sentence structure tree, such as parse tree. For example, the processing of the text content is held by a parser executed by the one or more processor(s) 204. The parser creates for each sentence a parse tree that represents linguistic relations between words in the sentence. The processing and optionally the parsing may be performed by a variety of text analysis tool, for example natural language processing (NLP) modules, such as Stanford's CoreNLP Suite, Natural Language Toolkit (NLTK), OpenNLP, GATE, and/or the like.

The parse tree optionally contains three levels of syntactic analysis: a constituent structure, a syntactic category of each one of the constituents, and a grammatical function for each constituent.

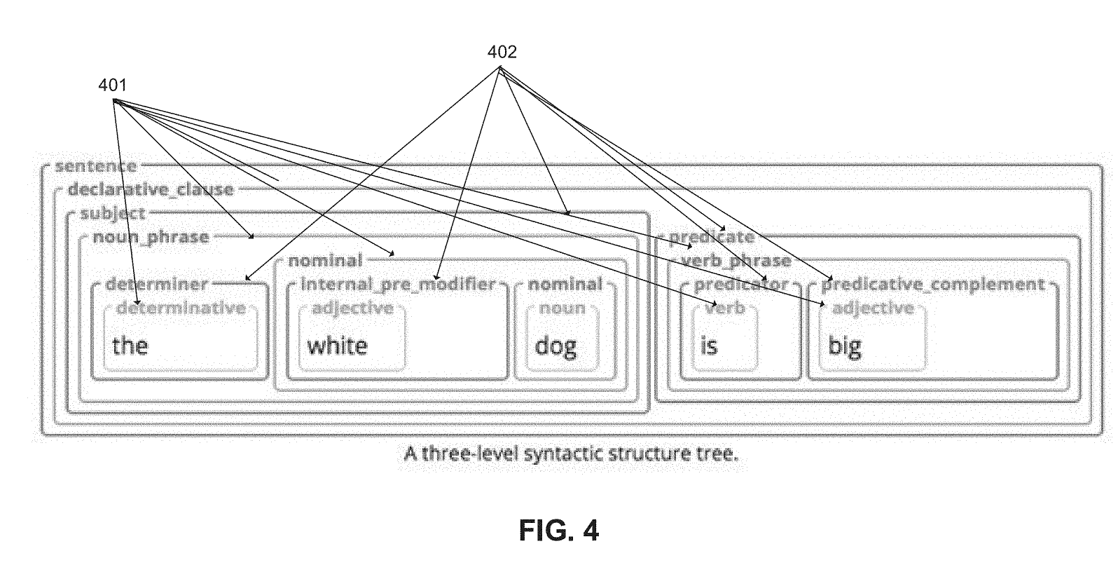

The constituent structure of a sentence specifies which words in the sentence combine to form a larger part of the sentence, for instance pair of words phrases, and which larger parts combine to form even larger parts, for instance word triplet phrases or quadruplet word phrases and so on and so forth. For example, in FIG. 4 which depicts a three level parse tree, rectangles 401 carry syntactic categories and rectangles 402 carry grammatical functions. For instance, rectangle 403 encircles a string of words “the white dog” in the syntactic category “noun phrase”, and rectangle 404 corresponds to a grammatical function “subject”. The syntactic category of the constituent “the white dog” is noun phrase and its grammatical function in the sentence is a subject. In such embodiments, syntactic categories of one-word constituents are parts of speech of words (noun, verb, adjective, etc.).

Optionally, each parse tree contains a set of attributes for every word. The attributes may include an indication whether a word is singular or plural (for nouns), a form attribute (for verbs), and/or the like. For example, a count attribute for “dog” has the value of “singular” and a form attribute for “is” has value of “present_tense-3rd_singular”.

Optionally, each sentence is parsed into a parse tree. Optionally, a complex sentence is parsed into a plurality of parse trees. An exemplary complex sentence comprises two independent clauses which are joined using a conjunction. Such a sentence may be divided to two simple sentences by removing the conjunction and building a different parse tree for each simple sentence. Another example of an optional complex sentence is a sentence that contains an independent clause and a dependent clause or two or more independent clauses and at least one dependent clause. Such a sentence may be split to allow building a different parse tree for each clause.

Optionally, after the processing, a map between sentences in the textual content and a plurality of parse trees is created. The map, optionally stored in a mapping file, holds, for every word in the textual content, a reference to the parse tree that maps the word and to an index of the word in the parse tree. For example the following table:

| | | The word index |
|---|---|---|
| Word index in the | | within the parse- |
| sentence | The parse-tree file | tree file |
| 1 (I) | file1 | 1 |
| 2 (don't) | file1 | 2 |
| 3 (like) | file1 | 3 |
| 4 (coffee) | file1 | 4 |
| 5 (thank) | file2 | 1 |
| 6 (you) | file2 | 2 |

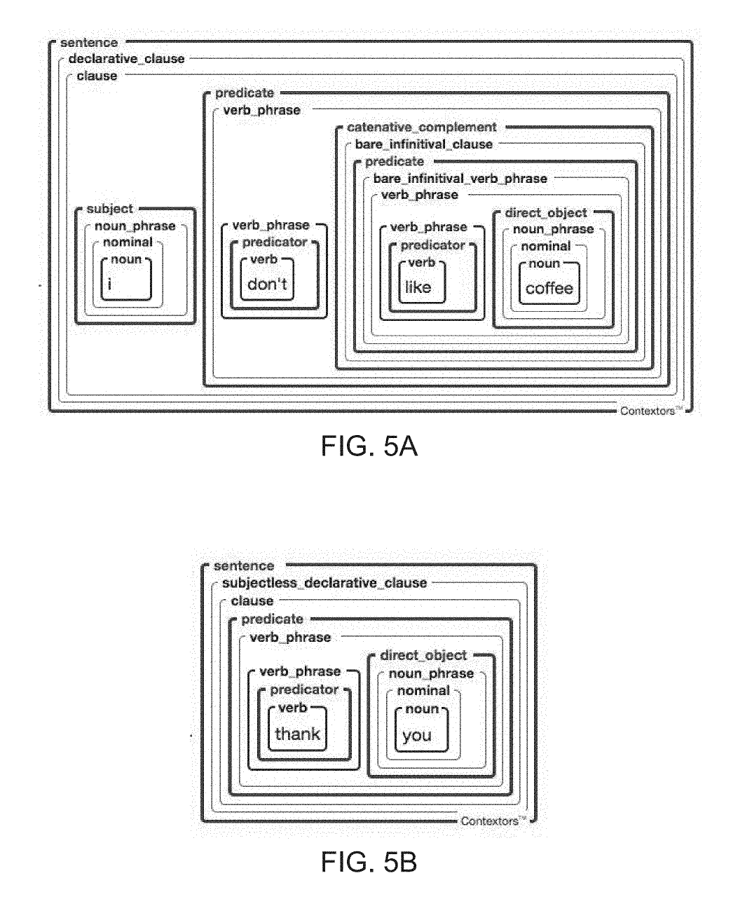

maps between each word in the sentence “I don't like coffee, thank you” and one of the two trees depicted in FIGS. 5A-5B.

Optionally, as shown at 102, a multi feature object, referred to herein as a sentence object, is built for each sentence by an analysis of the respective parse tree by the one or more processor(s) 204. A sentence object may be generated by identifying a part of speech of each word mapped in a parse tree and tagging it, for example as a noun, a verb, and/or an adjective. Additionally or alternatively, a grammatical function and/or a syntactic category of constituents are identified and added to the sentence object. Additionally or alternatively, attributes of each word mapped in a parse tree are identified, optionally based on the respective part of speech and added to the sentence object.

Attributes of sentences may be a map of sentence parts, a sentence type (e.g. declarative, interrogative, and/or the like), a sentence sub-type (e.g. copular, existential, and/or the like), a sentence tense (e.g. past simple, present perfect, and/or the like), a sentiment (e.g. positive, negative, and/or the like) and/or a voice (e.g. active or passive). For instance, when the word is a verb, its form and its inflection in a plain form are fetched and added to the sentence object. When a word is a verb and it appears in contraction (e.g. 's in John's), its stem is checked (e.g. the stem of 's in John's is “be”).

Additionally or alternatively, the sentence object is enhanced with data gathered from a dictionary, for instance by automatically fetching a definition for each word. This process fetches, for each word, a definition from a dictionary database. Optionally, only definitions which match the word's part of speech are fetched.

For example, the word “answer” is a noun in the sentence “I gave you an answer” and a verb in “please answer the question”. Different definitions will be fetched for the same word in each one of the sentences.

Now, as shown at 103, one or more interactive text related object template(s), for example from a template database 210, are matched with one or more sentences in the text content. Each template optionally associated with template conditions, for example rules defining certain one or more attribute(s), type(s) and/or role(s) of words and/or sentences. In such embodiments, a sentence is matched with an interactive text related object template by detecting a compliance of features of a sentence object with rule(s) or conditions which are defined for the template by the one or more processor(s) 204. This allows matching text related object templates to sentence objects based on attribute(s), type(s) and/or role(s) of words and/or sentences which comply with the template conditions.

Optionally, an interactive text related object template is a template of a challenge or a linguistic educational item. The template include instructions to generate a GUI for instance which data to extract from the matching sentence object and how to use it in order to fill in questions templates, answer templates and/or explanation part templates. Optionally, a template includes a script for activating a search engine, a call function or an API call for acquiring content such media content based on the sentence object data.

Optionally, each of all or some of the interactive text related object templates is adapted to a number of languages. In such a manner, explanations questions or answers can be provided at a language of choice.

Indications of one or more matched interactive text related object templates are optionally added to respective matched sentence objects to allow using the template in the future.

Now, as shown at 104, interactive text related objects are created by the one or more processor(s) 204 by placing data from each matched sentence object in respective interactive text related object template. A created interactive text related object may be a multiple answer question, a challenge to mark or complete a word or a phrase, educational information window that includes information about a word or a term or phrase, an animation or a media file adapted to be played with a respective sentence and/or the like. Optionally, the created interactive text related object includes explanation set to be presented to a user, for instance explanation automatically generated based on the data from the respective sentence object.

Optionally, interactive text related object templates or text related objects are selected based on historical performances of the user. In such an embodiment, previously used interactive text related object templates or text related objects may be selected to be presented to the user only if no other interactive text related object templates or text related objects are found and/or after a period. Optionally, when a user correctly answer a challenge based on a certain text related object template, other text related objects of different templates receive a higher rank to allow improving weaker abilities of the user.

Optionally, interactive text related objects or text related objects are selected based on the linguistic level of the user, for instance a linguistic level dynamically estimated based on historical performances of the user. The linguistic level, also referred to herein as a user level, is based on one or more scores given to the user in linguistic skills such as grammar topics, vocabulary and/or the like. In such embodiments, a user level may be ranked in real time according to the correctness of his answers to challenges. Templates may be marked with a user level indication, allowing matching objects to the level of the user. Additionally or alternatively, the level of the user may be estimated based on the level of the text content and/or a user profile determined from an analysis done by a third party or selected by the user himself. Additionally or alternatively, a user level is set by an operator, for instance a third party such as a teacher or a guardian.

For example, a parse tree of the phrase “his car” is indicative that the case of the pronoun ‘his’ is ‘dependent_genitive’. The dictionary may provide the other cases of the pronoun ‘his’: {:nominal=>“he”, :accusative=>“him”, :dependent_genitive=>“his”, :reflexive=>“himself”, :independent_genitive=>“his”}. Another example is a template of a Wh challenge (see more below) filled with data from this parse tree and the dictionary:

{

:word_id => s1w1,
:challenge_type => wh_challenge,
:correct_answer => ‘dependent_genitive’,
:options => {:nominal=>”he”, :accusative=>”him”,
:dependent_genitive=>”his”, :reflexive=>”himself”},

}

A Wh challenge adapted to be translated to different languages so as to provide a user with a user experience at his native language may be defined as follows:

{

:question => “Choose the correct pronoun form according to its role in the
sentence (subject, direct object, reflexive, etc.).”,
:explanations => {
:nominal=>”The basic form <i>{{nominal_lem}}</i> appears in subject
position.”,
:accusative => ”<i>{{accusative_lem}}</i> is the form of
<i>{{nominal_lem}}</i> which is used in direct or indirect object position.”,
:dependent_genitive => ”<i>{{dependent_genitive_lem}}</i> refers to
something which relates to or belongs to <i>{{accusative_lem}}</i>. The
pronoun <i>{{dependent_genitive_lem}}</i> appears before the related object,
e.g. <i><b>Their idea</b> was to build a house</i>.”, :reflexive =>
”<i>{{reflexive_lem}}</i> is the reflexive form of <i>{{nominal_lem}}</i>. It
appears in object position when <i>{{nominal_lem}}</i> is also the subject of
the clause, for example: <i><b>John</b> bought <b>himself</b> a present for
his own birthday</i>. The word <i>himself</i> also refers to <i>John</i>.” }

}

Now, as shown at 105 and 106, the interactive text related objects are embedded by the one or more processor(s) 204 or the one or more processor(s) 201 of the mobile device 190 in the textual content and/or in a presentation of textual portion(s) having sentences documented in matched sentence objects, causing a text content rendering application, such as an app store application or a browser executed on a client device to present the interactive text related objects, each optionally simultaneously with an updated version of a respective text section in which one or more linguistic elements from the matched sentence object are marked or covered and an interactive GUI adapted to receive an answer to be presented via a man machine interface (MMI) of the client device.

It should be noted that when the interactive text related objects are embedded by the one or more processors 201 of the mobile device 190, the interactive text related objects may be sent from the system 200 over the network 211. In such embodiments, the system 200 accesses the text content for an analysis and the mobile device 190 separately and independently accesses the text content for presentation of at least portions thereof together with the interactive text related objects which are received from the system.

In one use case, the client device accesses text content, such as textual content in webpage and an indication of the text content is sent to the system 200. The system 200 analyzes the textual content for building interactive text related objects as described above. The built interactive text related objects are sent for being embedded for simultaneous presentation of respective portions of the textual content. In such a manner, when a portion of the text content that includes a certain sentence is presented to a user of the client device, an interactive text related object built using data extracted from the sentence object of the sentence is presented. Created interactive text related objects may be stored for future usages by the same user or other users, for instance at the system 200.

Optionally, the textual content embedded with the interactive text related objects and/or the interactive text related objects are sent as a JavaScript Object Notation (JSON) to the rendering module such as an application or a browser executed on the client device, see also FIG. 3.

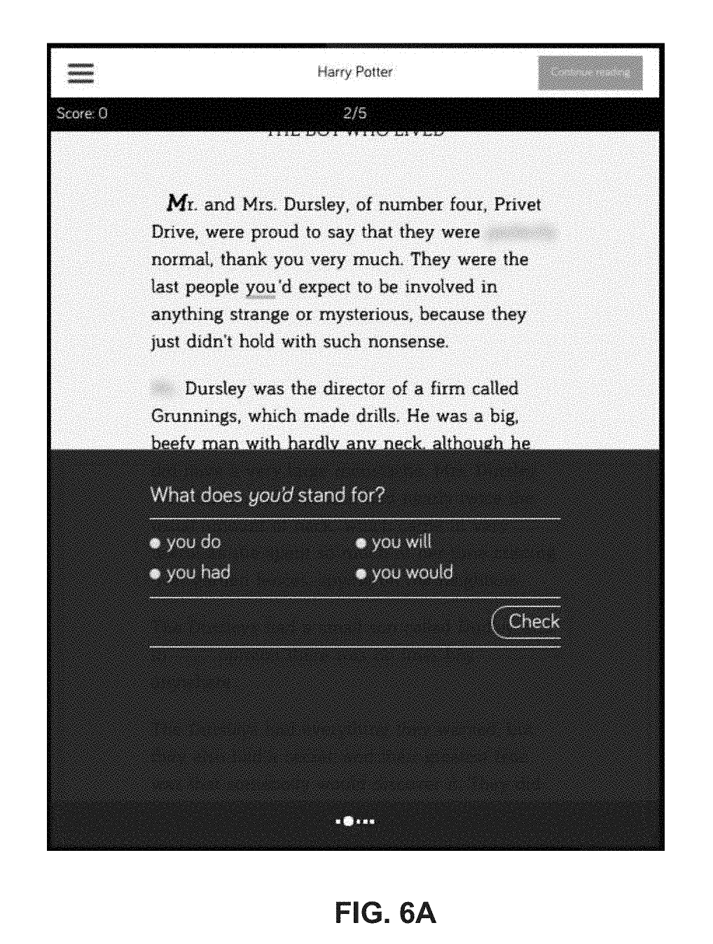

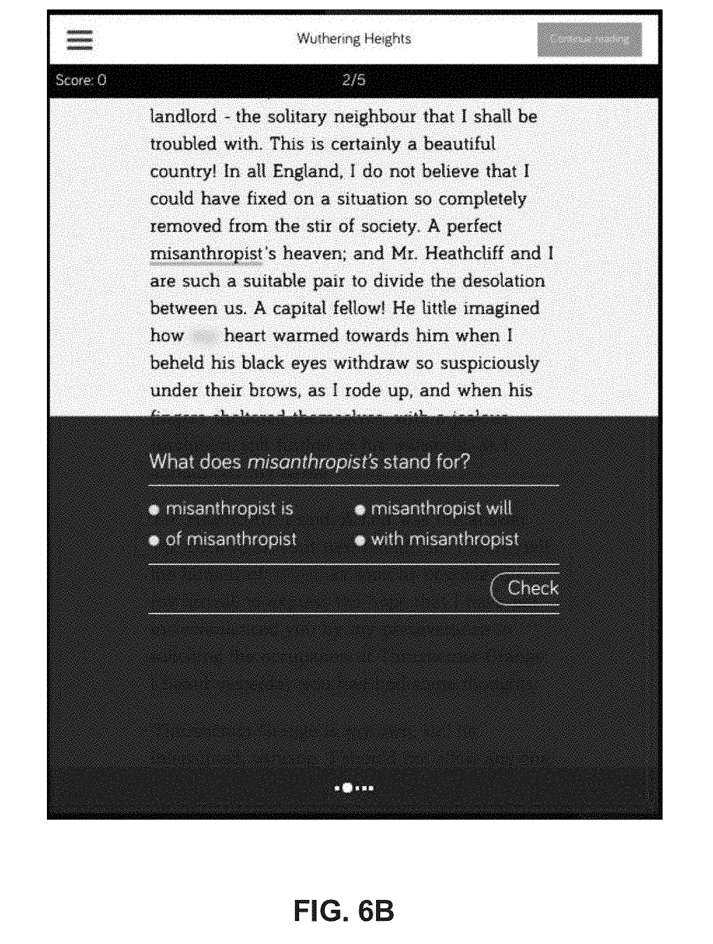

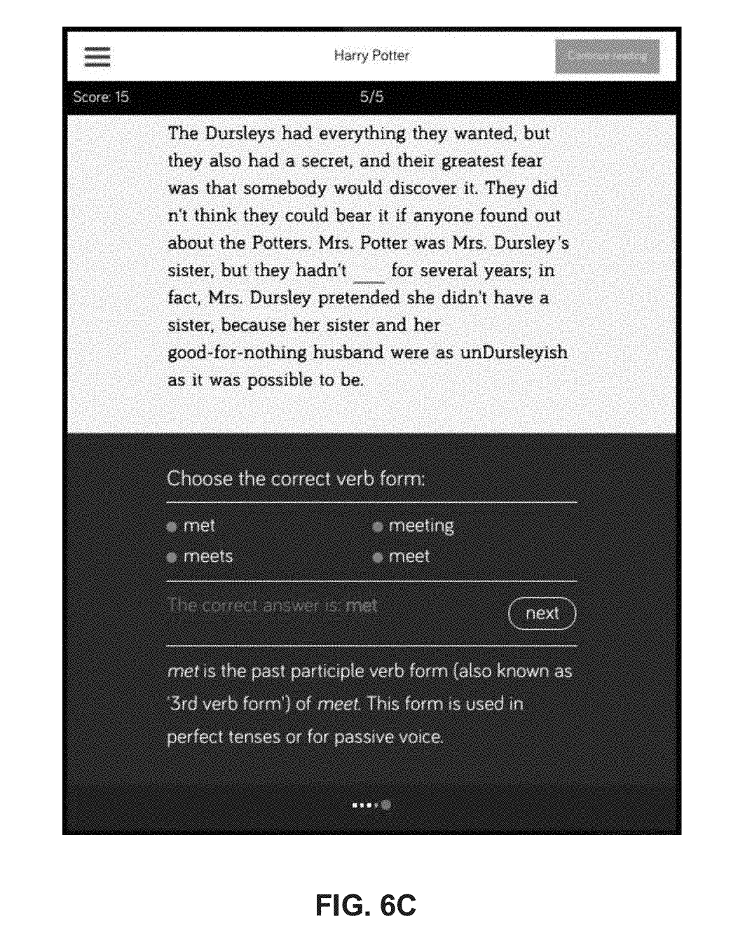

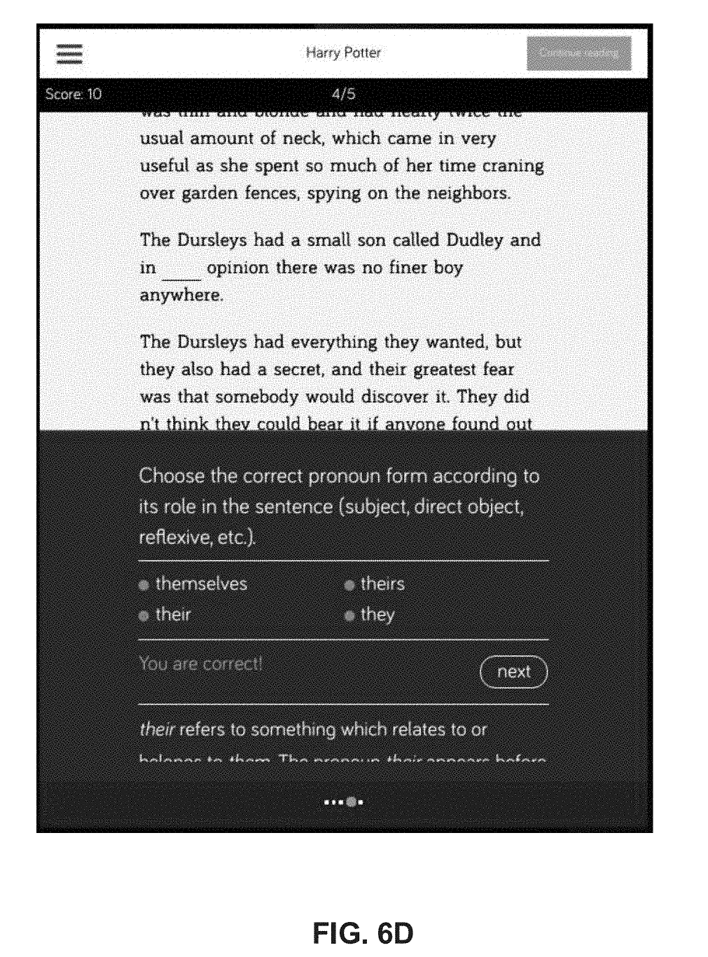

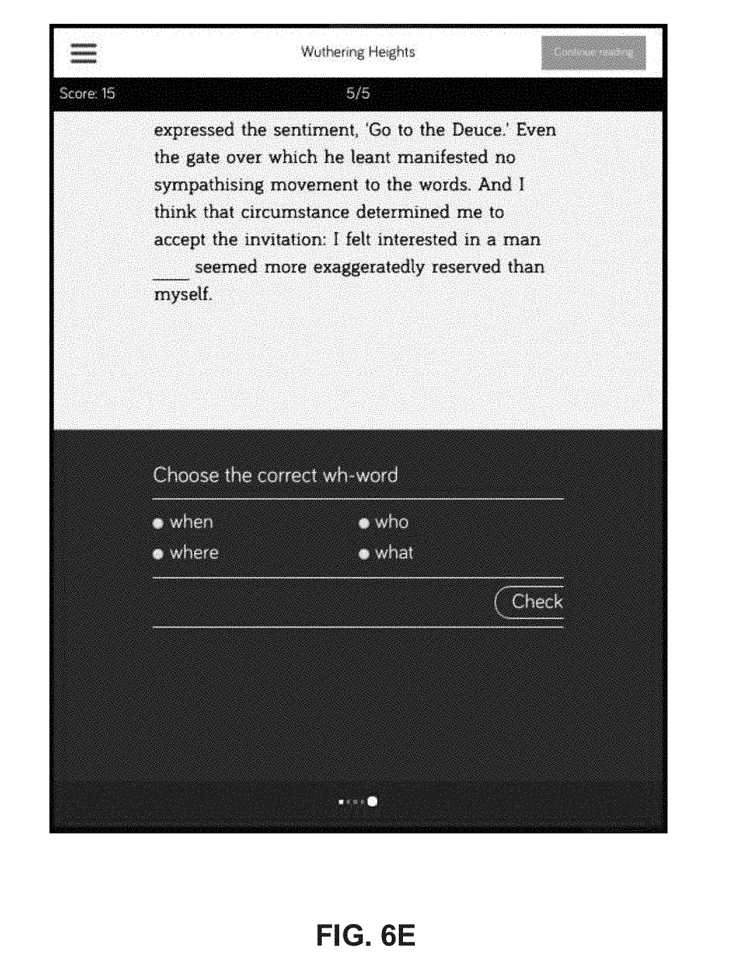

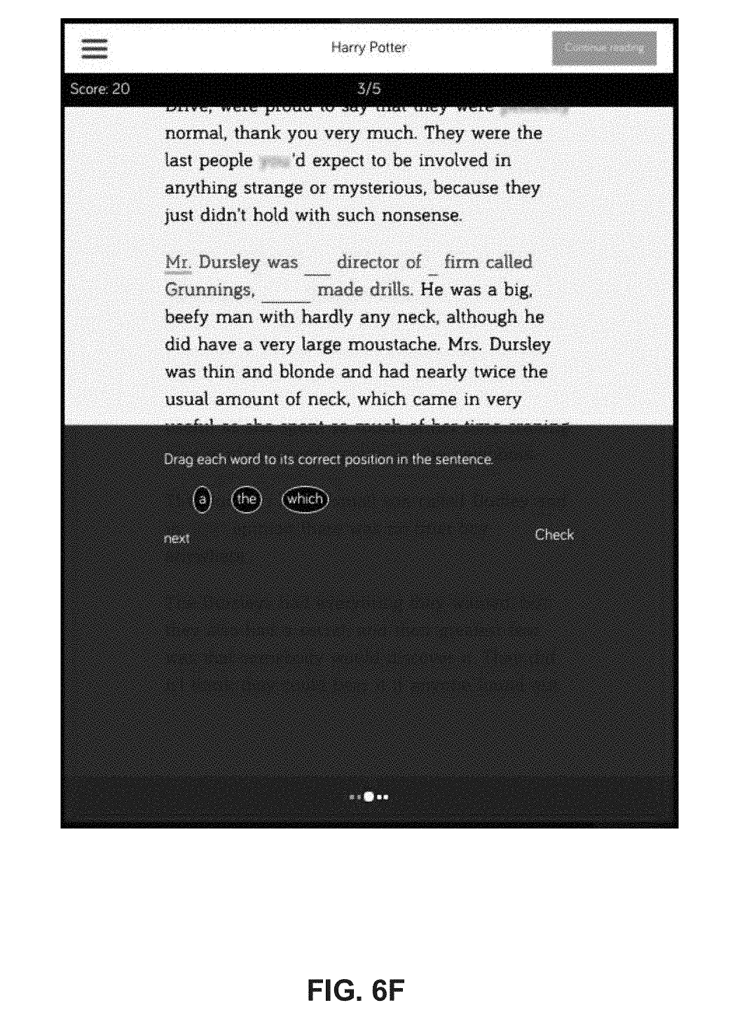

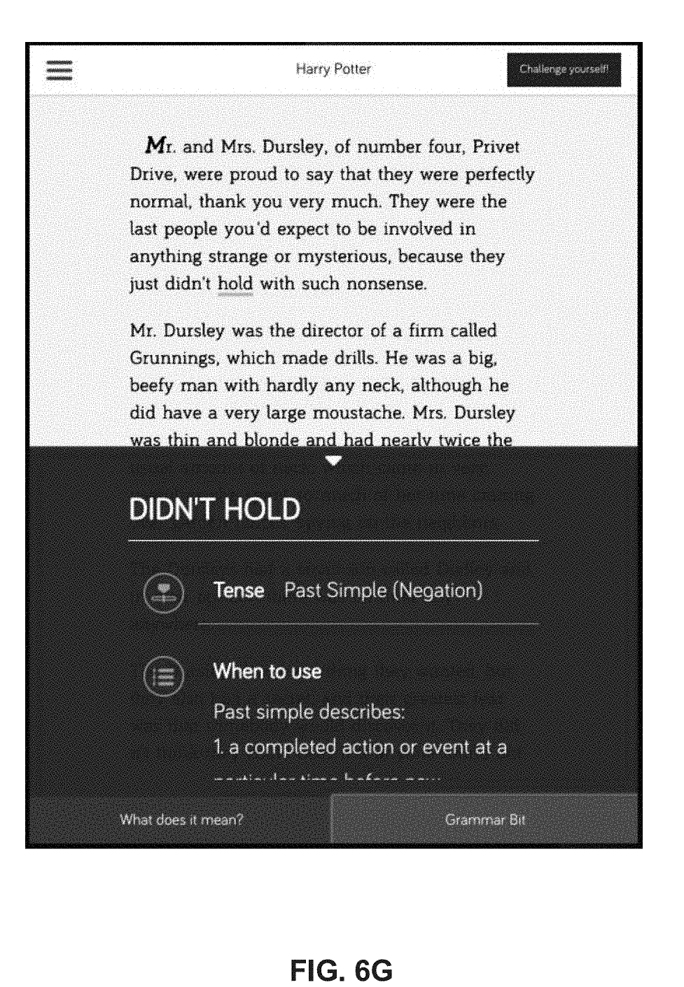

Reference is now made to a number of examples. For example, FIG. 6A is a screenshot of a challenge created using a template that includes the question indicative of what “XXX'd” stands for?. In order to determine whether “d” represents “would” or “had”, data from the respective Sentence Object is used and matched with a number of conditions to determine which answers to build and how. When the verb following the “d” has a plain form, “d” is a shortcut for “would” and when the verb following the “d” has a past participial form, then “d” is a shortcut for “had”. This information is found in the sentence object.

Another example is depicted in FIG. 6B which is a screenshot of a challenge created using a template that includes the question what “XXX's” stands for? In this example, the Sentence Object data is analyzed to determine what “s” represents, for example “is” or a genitive marker. When it has a part of speech of genitive, then it's a genitive marker and when the data indicate that the “s” is an inflection of the auxiliary verb “be”, then it's a shortcut for “is”. It should be noted that the questions and answers of the challenges depicted in FIGS. 6A-6B are presented in parallel to a text portion including the respective sentence based on which the challenge is created and a marking of a word or a portion of a word in question, for instance marked with an under line.

Another example is depicted in FIG. 6C which is a screenshot of a challenge created using a template that includes a Verb inflection challenge. In this template, a verb is hidden in a presentation of a text portion that includes a sentence and three false answers and one correct answer are calculated based on the verb's stem with different inflections (verb inflections are optionally extracted from the dictionary as described above). After the user chooses which of the inflections fits the empty space in the sentence, a grammatical explanation may be presented about the right form of the verb. The respective parse tree is analyzed to determine the right form of the verb.

For example, the parse tree is used for distinguishing between the following: i. “I put the ball there”, ii. “Put the ball there” and iii. “The ball was put there”. Although the same verb appears in the three sentences, it has a different form in each of them. An explanation in the verb inflection challenge, for example for the first sentence, refers to the fact that the verb's form is a preterite, while explanation for the second sentence refers the verb's form as plain (imperative), and explanation for the last sentence refers to the type of “was” which is “auxiliary passive” and for the form of “put” as past participle.

Another example is depicted in FIG. 6D that presents a case challenge to choose a missing word in a sentence, for instance choosing “her” as a missing word in the sentence that includes the following: “sister”. In this challenge template, an original word is hidden and a right answer together with three false answers having the same pronoun with inflections for different cases are presented (optionally the pronoun with inflections are extracted from the dictionary). After the user chooses which of the inflections fits the empty space in the sentence, a grammatical explanation about the right case of the pronoun is presented. The respective parse tree is analyzed to determine the right pronoun. For example, the respective parse tree is used to distinguish between: i. “You are here” and ii. “Thank you very much” where although the word “you” appears in both sentences, it has a different role in each sentence. Hence the explanation for the role of “you” will be “You is in subject position” for the first sentence, and “You is in object position” for the last sentence. Similarly, the respective parse tree may be used to distinguish between two different “his” (as in “This is his car”/“This is the car of his”) and “her” (as in “This is her car”/“I talked to her”), for providing right explanations accordingly.

Another example is depicted in FIG. 6E that presents a Wh challenge to choose a missing word in a sentence, for example wherein an original “Wh” word is identified in a sentence and hidden. The challenge is generated by hiding the word and presenting a right answer and three false answers—“Wh” words. In the depicted example below, the word “what” is the missing word in the sentence “The Dursleys shuddered to think _ the neighbors would say . . . ”.

Another example is depicted in FIG. 6F that presents a Drag 'n drop challenge wherein few words are hidden from a user. In this challenge the user is requested to drag and drop the right word to each empty space in the sentence. Optionally, hidden words may be prepositions, determinatives, and/or determiners, based on a predefined rule or condition. The selection may be based on grammatical functions data that is documented in the sentence object.

As indicated above, the dynamically built interactive text related objects may be linguistic educational items. For example, a template that is used to identify a verb sequence that contains the clause's tense may be used. This template may be used to present additional information about the clause. For example FIG. 6G is a screenshot of an educational item shown when the user clicks on the word ‘hold’ in the sentence “ . . . they just didn't hold with such nonsense”. Information about the sequence “didn't hold” may include that it's a Negation form in past simple tense, and indicate when to use it and what is the right way to form it.

Linguistic educational item may be linguistic description of a phrase in question. An exemplary item may include description about: negative-polarity-item (e.g. ‘any’ vs. ‘some’ in “They didn't have any dogs” and “They had some dogs”), a complement frame of a verb (e.g. the verb ‘send’ takes both direct and indirect objects in “They sent him a present”), a kind of determiner (e.g. definite/indefinite: ‘a’, ‘the’; quantifiers: ‘all’, ‘every’; etc.), or a construction of relative clauses (e.g. “John likes the present that they sent him”).

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a module, a processor and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for enhancing a text presentation, comprising:
performing a linguistic analysis of a plurality of sentences, each comprising a plurality of linguistic elements, in a text content;
using analyzed data created by said linguistic analysis to match between a group of said plurality of sentences and a plurality of interactive text related object templates;
creating a plurality of interactive text related objects each for a member of said group, each one of said plurality of interactive text related objects is created by placing a respective said analyzed data into a respective said interactive text related object template; and
causing a client device to present simultaneously at least one of said plurality of interactive text related objects and a text section of said text content that includes a marking of at least one linguistic element of a respective member of said group.

2. The method of claim 1, wherein said performing a linguistic analysis comprises parsing said plurality of linguistic elements of each one of said plurality of sentences to one of a plurality of parsed syntactic structure trees; wherein said analyzed data comprises said plurality of parsed syntactic structure trees.

3. The method of claim 2, further comprising identifying enriching data related to at least some of said plurality of linguistic elements of at least some of said plurality of sentences by submitting a search query that includes data extracted using a respective said parse tree and using said enriching data for creating said plurality of interactive text related objects.

4. The method of claim 1, wherein said plurality of interactive text related objects comprises instructions to present a plurality of graphical user interfaces each having a question and a plurality of answers and adapted to react to a user selection made using a man machine interface of said client device.

5. The method of claim 1, wherein said plurality of interactive text related objects comprises instructions to present explanation content related to said at least one marked linguistic element.

6. The method of claim 1, further comprising identifying grammatical functions defining at least some of said plurality of linguistic elements of at least some of said plurality of sentences and using said grammatical functions for creating said plurality of interactive text related objects.

7. The method of claim 1, further comprising identifying dictionary data defining at least some of said plurality of linguistic elements of at least some of said plurality of sentences and using said dictionary data for creating said plurality of interactive text related objects.

8. The method of claim 1, further comprising identifying enriching data related to at least some of said plurality of linguistic elements of at least some of said plurality of sentences by executing a script and using said enriching data for creating said plurality of interactive text related objects.

9. The method of claim 1, wherein each one of said plurality of interactive text related object templates comprises at least one condition; wherein said match is found when data defining at least some of said plurality of linguistic elements complies with said at least one condition.

10. The method of claim 1, wherein said causing comprises forwarding said plurality of interactive text related objects to said client device over a network so as to allow said client device to embed said plurality of interactive text related objects into a presentation of said text content.

11. The method of claim 1, wherein said plurality of interactive text related objects is locally created by said client device.

12. The method of claim 9, wherein said plurality of interactive text related objects are encoded in a JavaScript Object Notation (JSON) file.

13. The method of claim 1, wherein text content is in a HyperText Markup Language (HTML) format.

14. The method of claim 1, further comprising selecting which of said plurality of interactive text related objects to present or which of said interactive text related object templates to use based on an estimation of at least one linguistic skill of a user.

15. The method of claim 1, further comprising selecting which of said plurality of interactive text related objects to present or which of said interactive text related object templates to use based on a level set by an operator.

16. The method of claim 1, wherein said plurality of interactive text related objects comprises instructions to present a graphical user interface adapted to allow a user to drag and drop dynamically created objects using a man machine interface of said client device.

17. The method of claim 1, wherein at least one of said plurality of interactive text related objects is a GUI comprising a question and multiple answers which are created by placing data extracted using said respective parse tree into said respective interactive text related object template.

18. A non transitory computer readable medium comprising computer executable instructions adapted to perform the method of claim 1.

19. A system for enhancing a text presentation, comprising:
a database comprising a plurality of interactive text related object templates;
a code store storing a code;
at least one processor coupled to said database for executing said stored code, the code comprising:
code to perform a linguistic analysis of each of a plurality of sentences in a text content, each one of said plurality of sentences comprises a plurality of linguistic elements;
code to use analyzed data from said linguistic analysis to match between a group of said plurality of sentences and a plurality of interactive text related object templates;
code to create a plurality of interactive text related objects each for a member of said group, each one of said plurality of interactive text related objects is created by placing data extracted using a respective said analyzed data into a respective said interactive text related object template; and
code to forward to a client device instructions to present at least one of said plurality of interactive text related objects in relation to a presentation of a text section of said text content that includes a marking of at least one linguistic element of a respective member of said group.
